(19) United States
(12) Patent Application Publication
(10) Pub. No.: US 2007/0124613 A1
(43) Pub. Date: May 31, 2007

(54) Information processing apparatus and system control method

(76) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/582,084

(22) Filed: Oct. 17, 2006

(30) Foreign Application Priority Data
Nov. 25, 2005 (JP) 2005-340287

(51) Int. Cl. G06F 1/00

(52) U.S. Cl. 713/300

(57) ABSTRACT

According to one embodiment, there is provided an information processing including a detector configured to detect whether a power is supplied and a controller configured to control the apparatus to be in an operable state when the detector detects the power is supplied.

### CROSS-REFERENCE TO RELATED APPLICATIONS

This application is based upon and claims the benefit of priority from prior Japanese Patent Application No. 2005-340287, filed Nov. 25, 2005, the entire contents of which are incorporated herein by reference.

### BACKGROUND

1. Field

One embodiment of the invention relates to an information processing apparatus which can be driven by an AC power supply and also to a system control method.

2. Description of the Related Art

In general, an information processing apparatus, such as a notebook computer (PC), is configured to be driven by either an AC power supply (commercial AC power supply) or a battery. In an environment where a PC is used by means of an AC power supply, the user can make the best use of the performance of the PC without taking the amount of remaining battery time into consideration. There are a variety of techniques to improve the operability of PCs and safety in using the AC power supply.

For example, Jpn. Pat. Appln. KOKAI Publication No. 10-97353 (hereinafter referred to as Document 1) discloses the following matter: When AC power is supplied, even if a power switch is turned off, power supply to a main memory is maintained; then, when the power switch is turned on, the system is restored to an operative condition based on the contents of the main memory.

Jpn. Pat. Appln. KOKAI Publication No. 2000-175347 (hereinafter referred to as Document 2) discloses the following matter: If an AC line cord plug is removed from the receptacle without turning off the AC switch, or if the AC switch is not turned off after a power cutoff, power will not be supplied to the apparatus unless the user intentionally turns on the AC switch, so that safety is ensured.

In the case where many information processing apparatuses, such as notebook computers (PCs), are used in an educational setting (e.g., a personal computer school) with AC power supply, an environment may be considered, in which all the information processing apparatuses can be easily turned on or off at a time. Generally, such an environment raises drawbacks, for example, decline in safety or operability of each PC.

The technique disclosed in Document 1 may be effective, if the user always desires to quickly restore the system to a condition as was immediately before the power off (resume). If not, however, the technique may be inefficient, because the power is wasteful.

The technique disclosed in Document 2 is safe but is not considered efficient, because if an AC line cord plug is removed from the receptacle without turning off an AC switch, or if the AC switch is not turned off after a power cutoff, power will not be supplied to the apparatus unless the user intentionally turns on the AC switch.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a state in which a display unit of a computer according to an embodiment of the present invention is opened;

FIG. 2 is an exemplary block diagram showing a system configuration of the computer;

FIG. 3 is an exemplary diagram showing an example of a setting screen, which allows setting of an operation mode that should be set when AC power supply is cut off or restarted;

FIG. 4 is an exemplary diagram showing a case where a plurality of computers of the same type as the computer shown in FIG. 1 are used in a personal computer school with AC power supply;

FIG. 5 is an exemplary diagram showing operations of each of the computers when a breaker is switched off and on in the structure shown in FIG. 4;

FIG. 6 is an exemplary block diagram showing a first configuration example to perform system control in accordance with cutoff/restart of AC power supply;

FIG. 7 is an exemplary sequence diagram showing a first operation example based on the configuration example shown in FIG. 6;

FIG. 8 is an exemplary block diagram showing a second configuration example to perform system control in accordance with cutoff/restart of AC power supply;

FIG. 9 is an exemplary sequence diagram showing a second operation example based on the configuration example shown in FIG. 8; and

FIG. 10 is an exemplary flowchart showing an operation flow common to the first operation example (FIG. 7) and the second operation example (FIG. 9).

### DETAILED DESCRIPTION

Various embodiments according to the invention will be described hereinafter with reference to the accompanying drawings. In general, according to one embodiment of the invention, there is provided an information processing apparatus including a detector configured to detect whether a power is supplied and a controller configured to control the apparatus to be in an operable state when the detector detects the power is supplied.

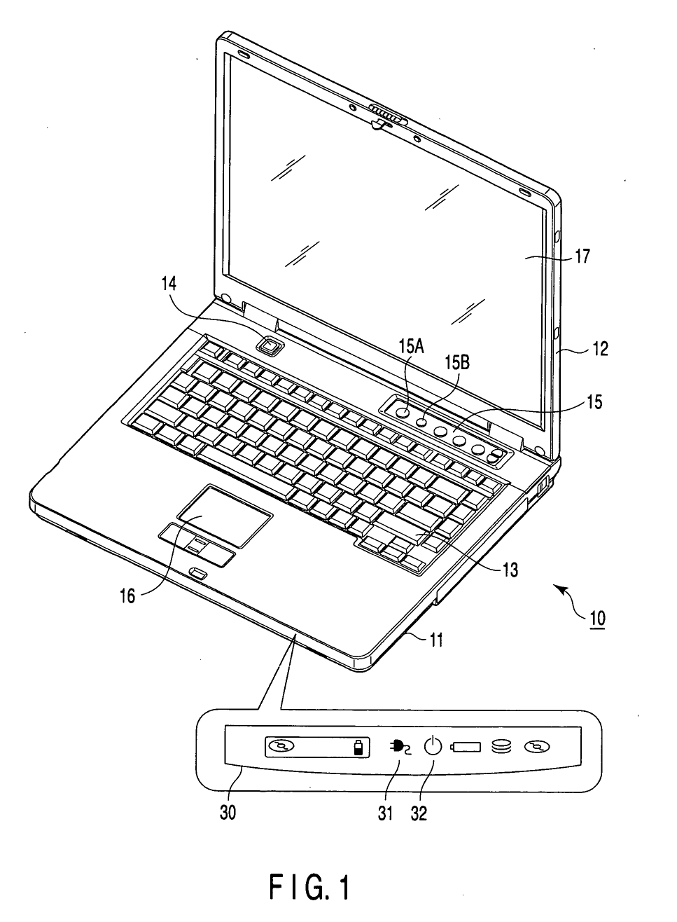

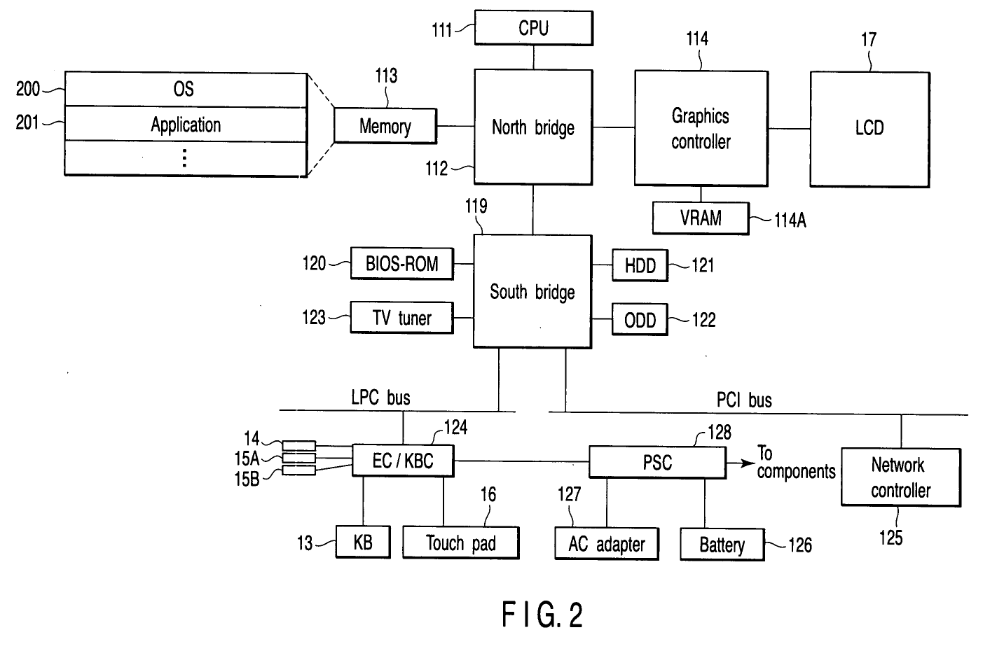

First, a configuration of an information processing apparatus according to the embodiment of the present invention will be described with reference to FIGS. 1 and 2. The information processing apparatus is implemented as, for example, a notebook computer 10.

FIG. 1 is a perspective view showing a state in which a display unit of the notebook computer 10 is opened. The computer 10 comprises a computer main body 11 and a display unit 12. The display unit 12 incorporates a display device comprising a TFT-LCD (Thin Film Transistor Liquid Crystal Display) 17. A display screen of the LCD 17 is located in a substantially central portion of the display unit 12.

The display unit 12 is attached to the computer main body 11 so as to be rotatable between an opened position and a closed position. The computer main body 11 has a thin box-shaped casing. The computer main body 11 comprises a keyboard 13, a power button 14 to power on/off the computer 10, an input operation panel 15, a touch pad 16, etc., which are arranged on an upper surface of the casing.

The input operation panel 15 is an input device, through which an event corresponding to a depressed button is input. It has a plurality of buttons to activate a plurality of functions, respectively. The group of buttons includes a TV activating button 15A and a DVD/CD activating button 15B. The TV activating button 15A is a button to activate TV function in order to play back, view, listen to and record TV broadcast program data. The DVD/CD activating button 15B is a button to play back video contents recorded in a DVD or CD.

A condition display section 30, which displays conditions inside the computer 10, is provided in a front surface of the main body 11. The condition display section 30 contains a plurality of indicators 31, 32, . . . . Operations of turning on and off the indicators are controlled by an embedded controller (EC) to be described later.

The indicator 31 indicates whether an AC adapter is connected or not (i.e., whether AC power is supplied or not). For example, green light illuminates when AC power is supplied, and goes out when AC power supply is stopped.

The indicator 32 indicates a condition of system power (ON state, OFF state, suspending state (or standby state), hibernation state (or halt state), etc.). For example, the indicator 32 emits green light when power supply is on, and puts it out when power is off. Further, the indicator 32 distinguishes between the suspending state and the hibernation state by a difference in color or a difference in flickering pattern of a predetermined color (e.g., orange).

A system configuration of the computer 10 will now be described with reference to FIG. 2.

As shown in FIG. 2, the computer 10 comprises a CPU 111, a north bridge 112, a main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124, a network controller 125, a battery 126, an AC adapter 127, a power supply controller (PSC) 128, etc.

The CPU 111 is a processor provided to control operations of the computer 10. It executes an operating system (OS) 200 and various application programs 201 loaded from the hard disk drive (HDD) 121 to a main memory 113.

The CPU 111 also executes a system BIOS stored in the BIOS-ROM 120. The system BIOS is a program for hardware control.

The north bridge 112 is a bridge device which connects the south bridge 119 with a local bus of the CPU 111. The north bridge 112 incorporates a memory controller which controls access to the main memory 113. Further, the north bridge 112 has a function for executing communications with the graphics controller 114 via an accelerated graphics port (AGP) bus.

The graphics controller 114 is a display controller, which controls an LCD 17 used as a display monitor of the computer 10. The graphics controller 114 displays video data written in a video memory (VRAM) 114A on the LCD 17.

The south bridge 119 controls devices on a low pin count (LPC) bus and devices on a peripheral component interconnect (PCI) bus. The south bridge 119 incorporates an integrated drive electronics (IDE) controller to control the HDD 121 and ODD 122. Further, the south bridge 119 has a function for controlling the TV tuner 123 and a function for controlling access to the BIOS-ROM 120.

The HDD 121 is a storage device which stores various software and data. The optical disk drive (ODD) 123 is a drive unit to drive memory media, such as DVDs and CDs, which store video contents. The TV tuner 123 is a receiver to externally receive broadcast program data, such as TV broadcast program.

The network controller 125 is a communication apparatus, which executes communications with an external network, such as the Internet.

The embedded controller/keyboard controller IC (EC/KBC) 124 is a one-chip microcomputer, in which an embedded controller to manage power and a keyboard controller to control the keyboard (KB) 13 and the touch pad 16 are integrated.

The power supply controller (PSC) 128 generates and supplies power necessary to the respective components of the computer 10 based on power from the battery 126 or external power externally supplied through the AC adapter 127 in accordance with instructions from the embedded controller (EC).

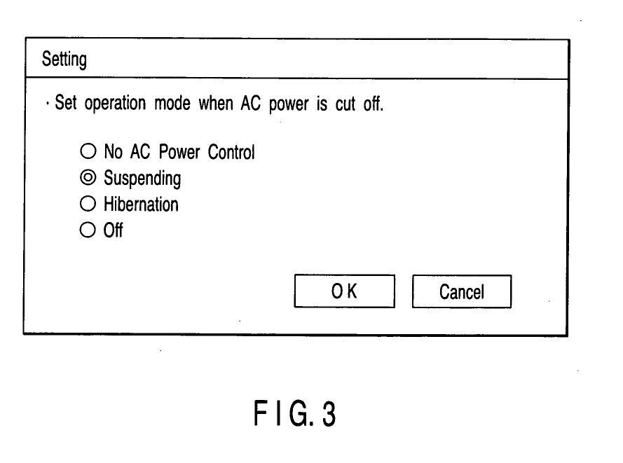

FIG. 3 is a diagram showing an example of a setting screen, which allows setting of an operation mode that should be set when AC power supply is cut off (disconnected) or restarted (connected). The setting screen is implemented by a power control setting application to be described later. The following operation modes (shut down modes) can be set in the screen:

No AC Power Control

Suspending

Hibernation

Off

When the user selects any one of these modes and pushes an OK button, the setting is completed.

For example, assume that “Suspending” (storing the system condition in a RAM or the like) is set as the operation mode (shut down mode) to be set when the AC power supply is cut off (disconnected). In this case, when the AC power supply is cut off, instruction information to instruct the system to activate upon restart of the AC power supply is stored in a predetermined memory area. Then, the system is shifted from the ON state to the suspending state (or standby state) and the operation is terminated. When the AC power supply is restarted (reconnected), “Resume” is executed in accordance with the instruction information. As a result, the system is recovered from the suspending state to the ON state.

Alternatively, assume that “Hibernation” (storing the system condition in a hard disk or the like) is set as the operation mode (shut down mode) to be set when the AC power supply is cut off (disconnected). In this case, when the AC power supply is cut off, instruction information to instruct the system to activate upon restart of the AC power supply is stored in the predetermined memory area. Then, the system is shifted from the ON state to the hibernation state (or halt state) and the operation is terminated. When the AC power supply is restarted (reconnected), “Recovery from Hibernation” is executed in accordance with the instruction information, with the result that the system is recovered from the hibernation state to the ON state.

Further, assume that “Off” (not storing the system condition) is set as the operation mode (shut down mode) to be set when the AC power supply is cut off. In this case, when the AC power supply is cut off (disconnected), instruction information to instruct the system to activate upon restart of the AC power supply is stored in the predetermined memory area. Then, the system is shifted from the ON state to the OFF state, and the system operation is terminated. When the AC power supply is restarted (connected), “Boot” is executed in accordance with the instruction information, with the result that the system is recovered from the OFF state to the ON state.

If none of the above three operation modes is set, and “No AC Power Control” is set, when the AC power supply is cut off (disconnected), the AC power-driving is changed to the battery-driving without storing instruction information or shifting the system condition. When the AC power supply is restarted, the battery-driving is changed to the AC power-driving.

Through the above process, when the AC adaptor or AC line cord is unexpectedly pulled out from the receptacle, as well as when a breaker 40 is switched off, the system of the computer completes it operation safely. Then, when the AC power supply is restarted, the system is returned to an appropriate condition that the user desires.

In the following, explanations will be given on the assumption that any one of the above three operation modes “Suspending”, ”Hibernation” and “Off” is set.

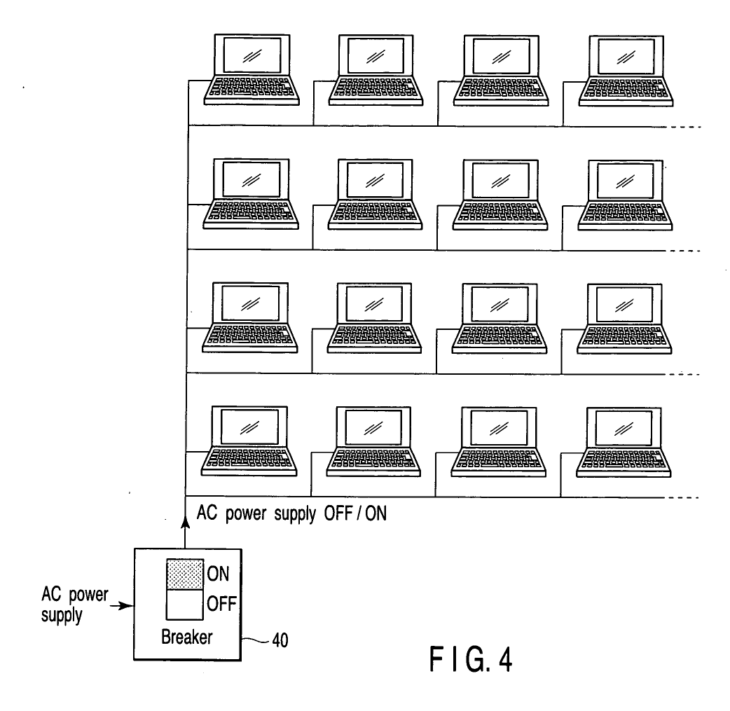

FIG. 4 is a diagram showing a case where a plurality of computers of the same type as the computer 10 are used in a personal computer school with AC power supply.

Each of the computers in a classroom of a personal computer school receives AC power via the breaker 40. AC power supply to all computers can be stopped or restarted by turning off or on the switch of the breaker 40.

In each of the computers, when the AC power supply is cut off, if any one of the above three operation modes “Suspending”, “Hibernation” and “Off” is set, instruction information to instruct the system to activate upon restart of the AC power supply is stored in the predetermined memory area. Then, the system is shifted from the ON state to the OFF state, and the operation is terminated. When the AC power supply is restarted, the system is activated in accordance with the instruction information by a process corresponding to “Resume”, “Recovery from hibernation” or “Boot”.

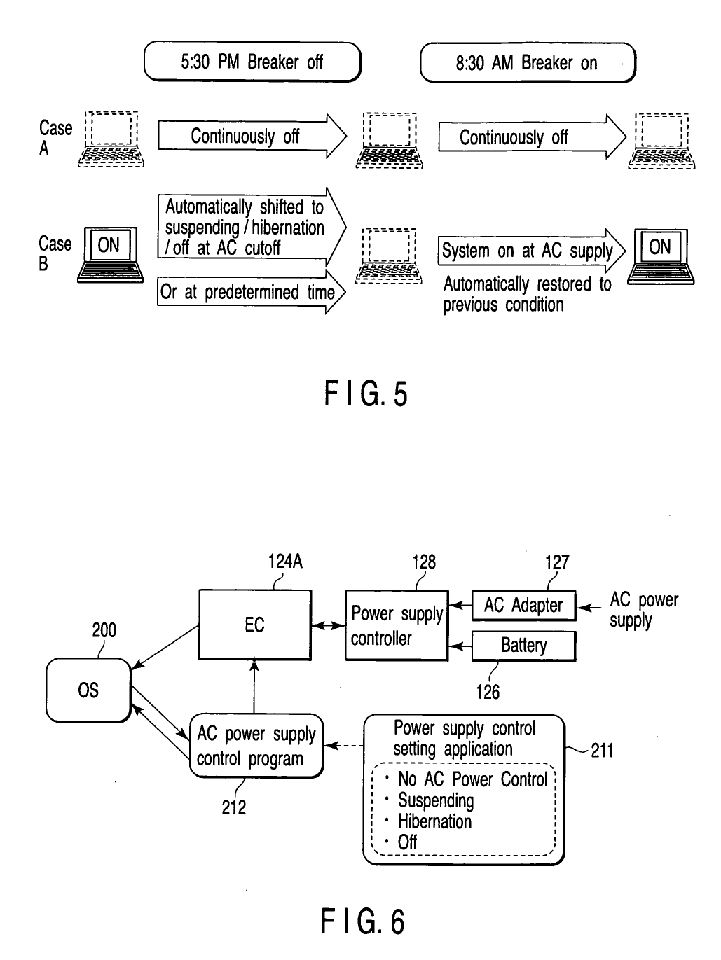

FIG. 5 is a diagram showing operations of each of the computers when a breaker is switched off and on in the structure shown in FIG. 4.

In this description, it is assumed that the breaker 40 in the classroom is turned off at 5:00 p.m. and turned on at 8:30 next morning.

Referring to a case A in FIG. 5, a computer, which is in the “off” state during the daytime, is continuously off after the breaker is turned off at 5:00 p.m. Even when the switch of the breaker 40 is turned on at 8:30 in the next morning, the system is still in the “off” state.

On the other hand, as in a case B in FIG. 5, a computer, which is in the “on” state during the daytime, is shifted to any one of the three operation modes “Suspending”, “Hibernation” and “Off” in accordance with the present mode, when the switch of the breaker 40 is turned off at 5:00 p.m. When the switch of the breaker 40 is turned on at 8:30 in the next morning, the system is activated in accordance with the instruction information, and performs a process corresponding to “Resume”, “Recovery from hibernation” or “Boot”. Thus, the computer is shifted to the “on” state.

FIG. 6 is a block diagram showing a first configuration example to perform system control in accordance with cutoff/restart of AC power supply. In FIG. 6, the same elements as those shown in FIG. 2 are identified by the same reference numerals as those used in FIG. 2.

The power supply controller 128 receives AC power via the AC adapter 127 and power from the battery 126, and supplies necessary power to the components of the computer. When the cutoff/restart of the AC power supply occurs due to the switch on/off of the breaker 40 or inserting/pulling out of the AC adapter 127 (or AC code), the power supply controller 128 transmits the information to an EC 124A.

When the EC 124A detects the cutoff of the AC power supply through the power supply controller 128, it notifies the OS 200 of that fact. When the EC 124A detects the restart of the AC power supply through the power supply controller 128, it activates the system in accordance with the instruction information set in the internal memory area. The EC 124A and the power supply controller 128 may be configured to be one unit.

The OS 200 transmits notification of cutoff of the AC power supply notified by the EC 124A to an AC power supply control program 212. It also performs a mode shift operation required by the AC power supply control program 212.

A power supply control setting application 211 operates under the control of the OS 200. It sets an operation mode designated by the user through the setting screen described above, and transmits the setting information to the AC power supply control program 212.

When the AC power supply control program 212 receives the notification of cutoff of the AC power transmitted from the OS 200, if the setting information obtained from the power supply control setting application 211 represents “Suspending”, “Hibernation” or “Off”, the program 212 causes a predetermined memory area (a register or the like) in the EC 124A to store the instruction information, instructing the system to activate upon restart of the AC power supply. In addition, the program 212 requests the OS 200 to set the operation mode corresponding to the setting information.

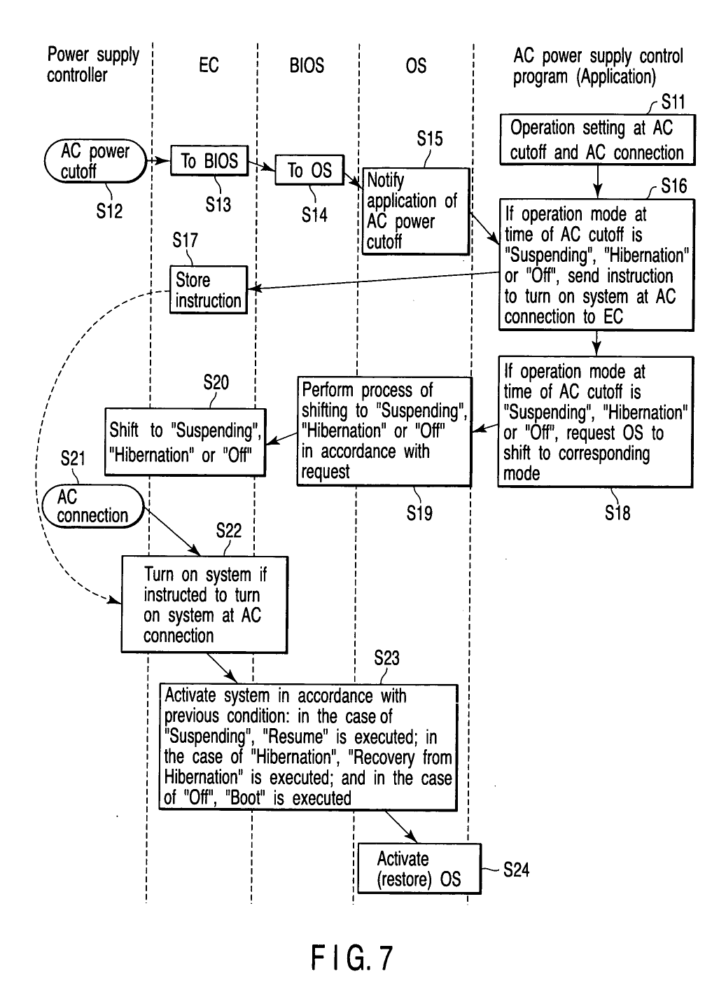

A first operation example based on the configuration example shown in FIG. 6 will now be described with reference to FIG. 7.

In the state where the computer is driven by the AC power supply, the power supply control setting application 211 sets an operation designated by the user through the setting screen (block S11). The set operation mode is transmitted to the AC power supply control program 212.

If the power supply controller 128 detects the cutoff of the AC power supply through the AC adapter 127 (block S12), the power source is changed to the battery 126. If the EC 124A is notified of the cutoff of the AC power supply, it notifies the OS 200 of the cutoff of the AC power supply via the BIOS (blocks S13 and S14). The OS 200, which has received the notification of the cutoff of the AC power supply, notifies the AC power supply control program 212 of the notification as an event (block S15).

Upon receipt of the event of the AC power supply cutoff, the AC power supply control program 212 sends an instruction to activate the system at the restart of the AC power supply to the EC 124, if the operation mode set by the power supply control setting application 211 in advance is “Suspending”, “Hibernation” or “Off” (block S16). Upon receipt of the instruction from the AC power control program 212, the EC 124A stores the instruction information indicative of the instruction in the internal memory (block S17).

Then, the AC power control program 212 requests the OS 200 to execute a shifting process corresponding to the operation mode (“Suspending”, “Hibernation” or “Off”) set in advance by the power supply control setting application 211 (block S18).

Upon receipt of the request from the AC power control program 212, the OS 200 executes a shift process corresponding to the operation mode indicated in the request, and notifies the EC of that fact (block S19). Upon receipt of the notification from the OS 200, the EC 124A changes the operation mode as requested, and sets the system power supply to a condition corresponding to “Suspending”, “Hibernation” or “Off” (block S20).

Thereafter, when the power supply controller 128 detects restart of the AC power supply from the AC adapter 127 (block S21), it uses the AC power supplied from the AC adapter 127. When the EC 124A is notified of the restart of the AC power supply, it refers to the instruction information stored in the internal memory. If the instruction information represents instruction to activate the system at the restart of the AC power supply, the EC 124A causes the system power to be on and the BIOS to be activated (block S22). Upon activation, the BIOS executes the system activation corresponding to the set operation mode (block S23).

For example, in the case of “Suspending”, “Resume” is executed; in the case of “Hibernation”, “Recovery from Hibernation” is executed; and in the case of “Off”, “Boot” is executed.

As a result, the OS 200 is activated (restored), and turned on (block S24).

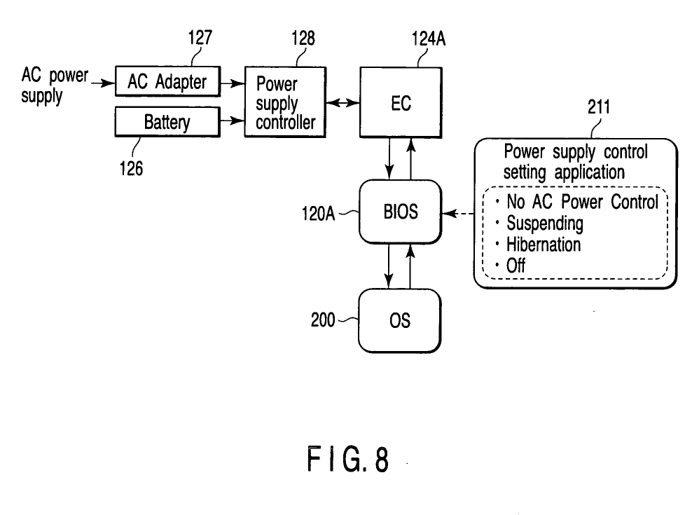

FIG. 8 is a block diagram showing a second configuration example to perform system control in accordance with cutoff/restart of AC power supply. In FIG. 8, the same elements as those shown in FIG. 2 are identified by the same reference numerals as those used in FIG. 2. In the following, explanations will be given mainly for those parts that differ from the first configuration example (FIG. 6) described above.

In the first configuration example (FIG. 6), the AC power supply control program 212 instructs the EC 124A to store the setting information or the OS 200 to perform operation mode shift when the AC power supply is cut off. In the second configuration example, a BIOS performs these processes. More specifically, when a BIOS 120A shown in FIG. 8 receives the notification of cutoff of the AC power supply from the EC 124A, if the setting information obtained from the power supply control setting application 211 represents “Suspending”, “Hibernation” or “Off”, the BIOS 120A causes a predetermined memory area (register or the like) in the EC 124A to store instruction information, instructing the system to activate at restart of the AC power supply. In addition, the BIOS 120A requests the OS 200 to set the operation mode corresponding to the setting information.

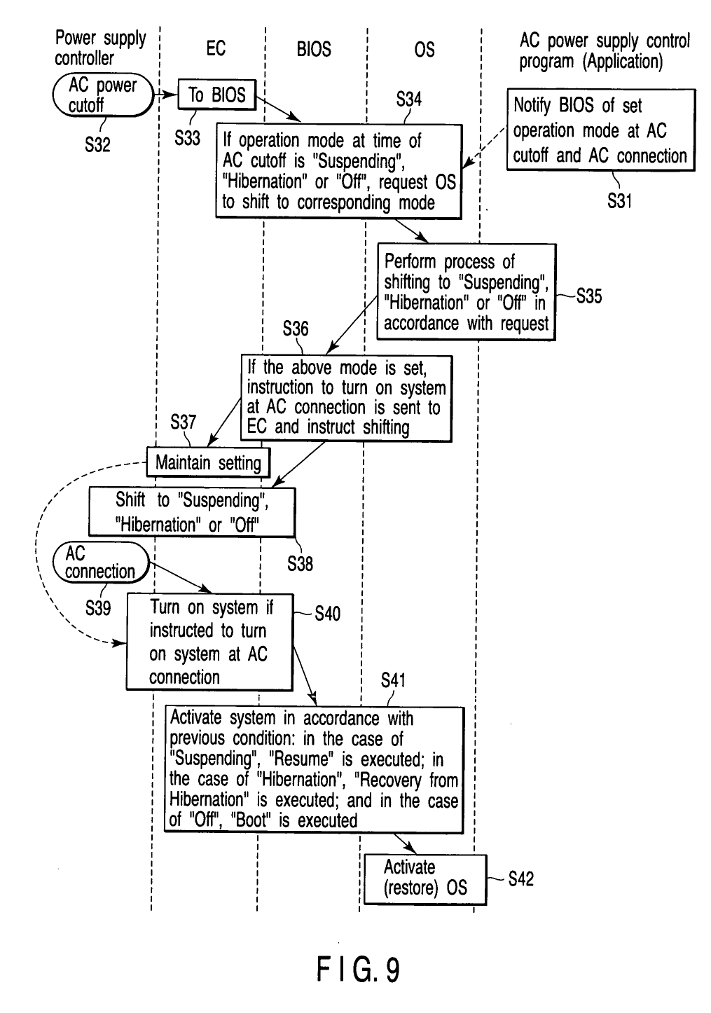

A second operation example based on the configuration example shown in FIG. 8 will now be described with reference to FIG. 9.

In the state where the computer is driven by the AC power supply, the power supply control setting application 211 sets an operation designated by the user through the setting screen. The set operation mode is notified to the BIOS 120A by the AC power supply control program 212 (block S31).

If the power supply controller 128 detects the cutoff of the AC power supply through the AC adapter 127 (block S32), the power source is changed to the battery 126. If the EC 124A is notified of the cutoff of the AC power supply, it notifies the BIOS 120A of the cutoff of the AC power supply (block S33).

When the BIOS 120A receives the notification of the cutoff of the AC power supply, if the operation mode which the Ac power control program 212 has notified of is “Suspending”, “Hibernation” or “Off”, the BIOS 120A requests the OS 200 to perform a process of shifting to the corresponding operation mode (block S34). Upon receipt of the request from the BIOS 120A, the OS 200 performs a shifting process corresponding to the operation mode as requested (block S35).

Then, the BIOS 120A sends an instruction that the system should be activated at the restart of the AC power supply to the EC 124A, and instructs the EC 124A to shift to the corresponding operation mode (block S36). Upon receipt of the instruction from the BIOS 120A, the EC 124A causes the internal memory to store the instruction information representing the instruction (block S37), and executes the shift to the operation mode as instructed (block S38).

Thereafter, when the power supply control 128 detects restart of the AC power supply from the AC adapter 127 (block S39), it uses the AC power supplied from the AC adapter 127. When the EC 124A is notified of the restart of the AC power supply, it refers to the instruction information stored in the internal memory. If the instruction information represents instruction to activate the system at the restart of the AC power supply, the EC 124A causes the system power to be on and the BIOS to be activated (block S40). Upon activation, the BIOS executes the system activation corresponding to the set operation mode (block S41).

For example, in the case of “Suspending”, “Resume” is executed; in the case of “Hibernation”, “Recovery from Hibernation” is executed; and in the case of “Off”, “Boot” is executed.

As a result, the OS 200 is activated (restored), and turned on (block S42).

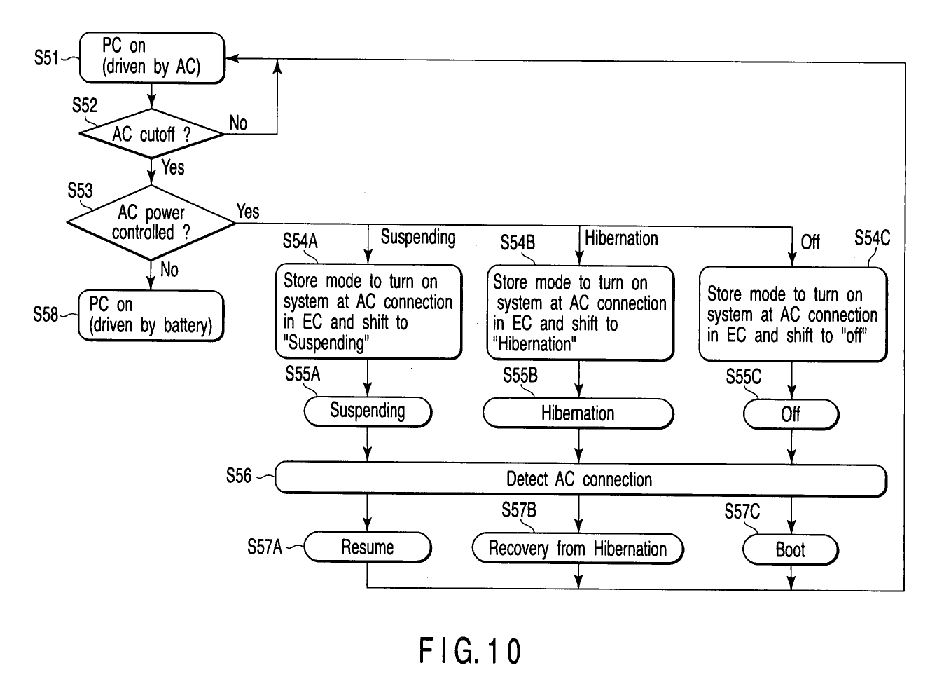

An operation flow common to the first operation example (FIG. 7) and the second operation example (FIG. 9) will now be described with reference to FIG. 10.

In the state where the computer is driven by the AC power supply (block S51), the power supply controller 128 and the EC 124A monitor whether the AC power supply is cut off or not (block S52). If the cutoff of the AC power supply is detected, the AC power supply control program 212 or the BIOS 120A determines whether to execute the AC power supply control based on the type of operation mode set by the power supply control setting application 211 (block S53).

If the set operation mode is “Suspending”, instruction information to instruct the system to activate at restart of the AC power supply is stored in a predetermined memory area in the EC 124A, and the operation mode is shifted to “Suspending” (block S54A and S55A).

If the set operation mode is “Hibernation”, instruction information to instruct the system to activate at restart of the AC power supply is stored in the predetermined memory area in the EC 124A, and the operation mode is shifted to “Hibernation” (S54B and S55B).

If the set operation mode is “Off”, instruction information to instruct the system to activate at restart of the AC power supply is stored in the predetermined memory area in the EC 124A, and the operation mode is shifted to “Off” (S54C and S55C).

Thereafter, when restart of the AC power supply is detected (block S56), the EC 124A refers to the instruction information stored in the internal memory area. If the instruction information represents that the system should be activated at restart of the AC power supply, the system power is turned on and the BIOS is activated. The BIOS, upon activation, executes the system activation corresponding to the set operation mode.

For example, in the case of “Suspending”, “Resume” is executed (block S57A); in the case of “Hibernation”, “Recovery from Hibernation” is executed (block S57B); and in the case of “Off”, “Boot” is executed (block S57C). As a result, the OS 200 is activated (restored), and turned on.

As described above, according to the embodiment of the present invention, especially in an environment where the AC power supply is used, the operability of the PC is improved while the safety is maintained.

In addition, in a personal computer school or the like, a plurality of computers can be turned on or off at a time through one AC path. Further, an AC adapter and AC line cord can be inserted and pulled out safely, and the system recovery as required by the user can be ensured. For example, if a computer is to be moved to another classroom, appropriate control can be carried out only by removing the AC adapter. In this case, therefore, it is unnecessary to operate a power source, such as a power switch. After the computer is moved, the system can be recovered and automatically turned on only by connecting the computer to the power supply via the AC adapter. Thus, the operability is significantly improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a detector configured to detect whether a power is supplied; and
a controller configured to control the apparatus to be in an operable state when the detector detects the power is supplied.

2. The information processing apparatus according to claim 1, further comprising a memory configured to store information that indicates whether the apparatus is to be placed in an operable state when the detector detects the power supply.

3. The information processing apparatus according to claim 1, wherein the controller is configured to place the apparatus into one of a plurality of shut down modes when the detector detects the power supply is disconnected.

4. The information processing apparatus according to claim 3, further comprising a user setting that permits a user to select one of the plurality of shut down modes.

5. The information processing apparatus according to claim 4, wherein the shut down modes comprise suspension, hibernation or off.

6. The information processing apparatus according to claim 5, further comprising a memory configured to store information corresponding to the shut down modes selected.

7. The information processing apparatus according to claim 6, wherein the controller is configured to shut down the apparatus according to the information stored in the memory when the detector detects the AC power supply is disconnected.

8. An information processing apparatus comprising:
a detector configured to detect whether a power is supplied;
a user setting that permits a user to select one of a plurality of shut down modes;
a memory configured to store information corresponding to the shut down modes selected;
a first controller configured to place the apparatus into one of the plurality of shut down modes when the detector detects the power is disconnected; and
a second controller configured to be in an operable state when the detector detects the AC power is supplied.

9. A system control method applied to an information processing apparatus comprising:
detecting whether a power is supplied;
storing a first information to a memory that indicates whether the apparatus is to be placed in one of a plurality of operable states when the power is supplied; and
controlling the apparatus to be in one of the plurality of operable states according to the information when the power is supplied.

10. The system control method according to claim 9, further comprising the steps of storing a second information corresponding to one of a plurality of shut down modes, and controlling the apparatus to place the apparatus in one of the plurality of shut down modes according to the second information when the power is cut off.

11. The system control method according to claim 10, wherein the shut down modes comprise at least one of suspension, hibernation or off.

12. The system control method according to claim 11, wherein the operable states comprise at least one of resuming from suspending, resuming from hibernation, or booting from an off state.
